(19) United States
(12) Patent Application Publication
(10) Pub. No.: US 2021/0287177 A1
(43) Pub. Date: Sep. 16, 2021

(54) AUTOMATIC MONITORING AND REPORTING SYSTEM

(71) Applicant: Moseley Ltd., London (GB)

(72) Inventors: Paul Tobin MUSIALEK, London (GB); Barnaby Jamie MUSIALEK, London (GB)

(21) Appl. No.: 17/197,223

(22) Filed: Mar. 10, 2021

(30) Foreign Application Priority Data
Mar. 10, 2020 (GB) 2003476.5

(51) Int. Cl. G06Q 10/10; G06Q 10/06; G06Q 50/04; G06Q 10/04; G06N 20/00

(52) U.S. Cl. CPC G06Q 10/103; G06Q 10/06395; G06Q 50/04; G06N 20/00; G06Q 10/06312; G06Q 10/04; G06Q 10/06313; G06Q 10/0635

(57) ABSTRACT

Disclosed herein is a computer-implemented method of monitoring the status of a project, the method comprising: generating workflow data in a standardised format by each of a plurality of users, wherein each user is a participant of the project; sending, by each of the plurality of users, the generated workflow data to a web-based platform; receiving, by the web-based platform, the generated workflow data from each of the plurality of users; automatically generating and updating an inspection and test plan in dependence on the received workflow data by the web-based platform; and generating substantially real-time progress status information of the project in dependence on the inspection and test plan. wherein: the inspection and test plan comprises a plurality of line items, each line item corresponding to a manufacturing step for a product; the generated workflow data in the standardised format by each user corresponds to one or more of the plurality of line items; and each manufacturing step is a step of manufacturing a product that is a component of a manufactured system, wherein the manufactured system includes a plurality of components with each of the plurality of components manufactured by a different user; and the method further comprises automatically: generating one or more metrics based on the workflow data, wherein each metric relates to a particular measurable parameter of the workflow data; analysing the one or more metrics using a machine learning algorithm, trained on historical performance data, to make predictions relating to risks associated with the inspection and test plan; and updating expected completion dates of one or more of the inspection and test plan line items in dependence on the analysis of the one or more metrics.

### CROSS-REFERENCE TO RELATED APPLICATION

This application claims the benefit under 35 U.S.C. § 119 of Great Britain Patent Application No. 2003476.5, filed Mar. 10, 2020, which is hereby incorporated by reference in its entirety.

### FIELD OF THE INVENTION

The present invention relates to a computer implemented method and system for monitoring the status of a project and automatically generating and reporting real-time progress status information of the project.

### BACKGROUND OF THE INVENTION

Embodiments of the present invention relate to technology for project management, in particular of large-scale “megaprojects”, that have a complex supply chain of sub-assemblies, packages, equipment and/or components that are delivered and combined at one or more site locations. These projects often last several years and may involve a worldwide network of supply chain partners (SCPs). Each SCP may build equipment that is delivered to the main site of the project for integration and use.

Major Engineering, Procurement and Construction (EPC) projects are often over schedule.

In oil and gas sectors, EPC projects are normally project managed either by the client directly or by a major EPC contractor. The project management business is normally the same entity that does the engineering and procurement phases of the project and then manages the supply chain and construction deliveries which are directly carried out by their SCPs. SCPs deliver equipment to construction sites for physical integration. Finally, the project management organisation then regains control of the finished product and commissions the systems ready for start-up and production operations.

Traditionally, complex projects start to face schedule issues at the time that the project becomes dependent on SCPs developing and delivering equipment. Hundreds of purchase orders (POs) are normally placed on large projects, representing approximately 30-50% of the total project cost.

As many of the client's equipment deliveries have dependencies on one another, it is important to maintain a tight control on the overall project schedule to check for slippages and potential knock-on effects. SCPs have their own schedules that are updated on a periodic basis (typically monthly) and presented to the client, along with the status of other core business-to-business (B2B) processes in the report. The client's project team must then validate and then integrate this information to determine the technical and project risks, and to monitor interdependency constraints that may be exceeded e.g. late delivery of one component impacting start dates for another SCP.

The client often integrates its SCP schedules with its own for this reason, so in-progress schedule data is fed back and updated in the client's high-level schedule. However, frequently the data provided by the SCPs is out of date by the time that it is received (normally SCPs have a reporting cut-off a week before the report is due), and is not validated until the client project team has checked and approved it. Additionally, there is a delay in determining what the inter-related supply chain risks are because the client project team must collectively examine all of the information presented by the SCPs. This includes other data that does not feature in their schedule but does affect the schedule of the project, for example, engineering actions resulting from design reviews, change management approvals, concessions, deviations, clarifications, non-conformances, inspection forecasts, inspection results, punch lists, etc. All of these items have an impact on the deliverables in the schedule but are ad-hoc, so are cannot be planned for as such. Thus, each line item in the schedule, be it a document, or a sub-purchase order, or a material delivery, carries an associated risk related to these actions that do not form part of the schedule. Documenting the status of these items is laborious, time consuming, and often inaccurate. Hence, there is an inherent uncertainty in the risk being carried at any point in time, making the project manager's task akin to a captain sailing a ship along the shoreline in fog without only a few lighthouses to go by.

Depending on the criticality of the items being procured, the client sends their own employees to verify what is reported in the field e.g. expeditors, quality control (QC) inspection, package managers, construction teams, etc. The more complex the supply chain, the bigger teams required to police this. Clients, however, have resource constraints and it is impracticable to police the whole supply chain. For the suppliers that are checked, the verification methods used are often done on an audit/sampling basis. In other words, during the delivery phase the client no longer has direct control of the work, and instead relies on assurance by means of sampling and audit. Hence, the risk of hidden quality defects and schedule delays in the supply chain is comparatively high. The knock-on effects of this often result in cost and schedule overruns.

There is therefore a general need to improve the control of processes in large projects and delivery or validated reliable data to the management team.

### SUMMARY OF THE INVENTION

An aspect of the invention provides a computer-implemented method of monitoring the status of a project, the method comprising: generating workflow data in a standardised format by each of a plurality of users, wherein each user is a participant of the project; sending, by each of the plurality of users, the generated workflow data to a web-based platform; receiving, by the web-based platform, the generated workflow data from each of the plurality of users; automatically generating and updating an inspection and test plan in dependence on the received workflow data by the web-based platform; and generating substantially real-time progress status information of the project in dependence on the inspection and test plan.

Optionally, the inspection and test plan comprises a plurality of line items, each line item corresponding to a manufacturing step for a product; and the generated workflow data in the standardised format by each user corresponds to one or more of the plurality of line items.

Optionally, each manufacturing step is a step of manufacturing a product that is a component of a manufactured system; wherein the manufactured system includes a plurality of components with each of the plurality of components manufactured by a different user.

Optionally, the plurality of line items each comprise at least one intervention point; and each intervention point is a trigger for performing a validation inspection of the corresponding manufacturing step for the product to be performed.

Optionally, the method further comprises predicting, in dependence on the inspection and test plan, when one or more line items are expected to be completed; and scheduling one or more intervention points in dependence on the predictions.

Optionally, the method further comprises receiving one or more inspection notifications that line items are ready from inspection from one or more of the plurality of users; and scheduling an intervention point in dependence on the received one or more notifications.

Optionally, the method further comprises automatically generating an inspection notification workflow in dependence on the inspection and test plan and the corresponding line item data; wherein the inspection notification workflow contains relevant information to the intervention point such as the related validation inspection procedure, reference documentation for the validation inspection procedure, and the location of the validation inspection procedure.

Optionally, the method further comprises automatically generating an inspection checklist for each intervention point, wherein each inspection checklist is generated in dependence on specification requirements of the manufacturing step associated with the intervention point.

Optionally, the method further comprises updating the inspection and test plan with a result of the validation inspection procedure.

Optionally, the method further comprises analysing the inspection and test plan using a machine learning algorithm trained on historical performance data; determining a risk matrix based on the analysis of the inspection and test plan, wherein the risk matrix identifies a likelihood of a line item of the inspection and test plan being delayed; and determining action suggestions in dependence on the risk matrix, wherein action suggestions are actions to reduce the risk.

Optionally, the method further comprises generating one or more metrics based on the workflow data, wherein each metric relates to a particular measurable parameter of the workflow data; analysing the one or more metrics using a machine learning algorithm, trained on historical performance data, to make predictions relating to risks associated with the inspection and test plan; and updating expected completion dates of one or more of the inspection and test plan line items in dependence on the analysis of the one or more metrics.

Optionally, the method further comprises reducing the amount and/or cost of re-worked processes in a project by: determining if an error has occurred; and applying data integration and/or artificial intelligence techniques in dependence on data that is determined for each error that occurs so as to reduce the amount and/or cost of re-worked processes in a project.

### BRIEF DESCRIPTION OF THE FIGURES

FIG. 1 is a graph showing a project's risk profile against the various stages in a project's lifecycle.

FIG. 2 shows a web-based platform in accordance with embodiments of the present invention.

FIG. 3 shows the web-based platform in communication with a plurality of users in accordance with embodiments of the present invention.

FIG. 4 shows an ITP in accordance with embodiments of the present invention.

FIG. 5 shows an inspection notification workflow in accordance with embodiments of the present invention.

FIG. 6 shows an inspection checklist in accordance with embodiments of the present invention.

FIG. 7 shows a flow diagram of using machine learning to predict key metrics.

FIG. 8 shows updating inspection and test plan status and date information from a workflow.

### DETAILED DESCRIPTION

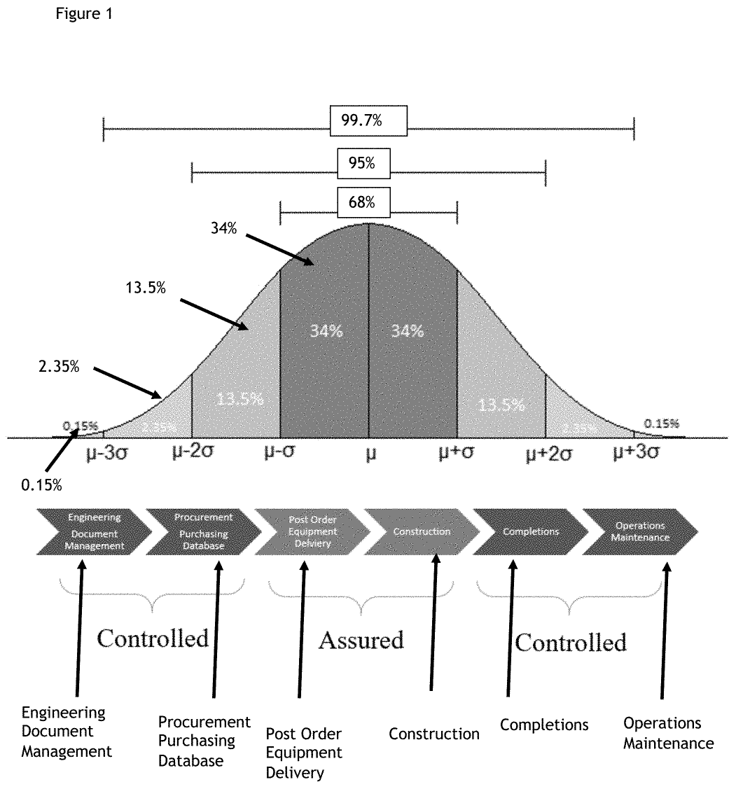

The risk profile as shown in FIG. 1 correlates directly with the quality of data profile on projects, meaning that during engineering and procurement phases data quality is good, because it is live and managed through established databases that control the verifiable outputs i.e. documents and purchase orders (POs). Towards the backend of projects, the data profile is good again because commissioning databases held by the project management organisation control this process. However, during the delivery phase there is a higher risk that project data is not reliable because of a lack of standard processes to capture and validate data at source and present it to the client. On more mature projects organisations, the client SCP interface is managed with well-defined processes, however, the data that is generated from these is often in paper form and only becomes digital if someone transcribes it. These processes are often email driven as this is the primary means of communicating. The data flow to the client management therefore goes across several hurdles before it can be properly validated. Data by is often owned by the SCP and the Client is reliant on what is reported. In addition, the information that is delivered is not being supplied in real-time as there are no digital workflows or structured databases to control or manage the work of the supply chain partners (SCPs). The SCPs manage their own deliveries using their own systems and databases. The client organisation, and/or or the project management organisation, is not directly supplied with the data generated by the SCPs, but instead relies on schedules, workflows supplied by the SCPs, quality control plans, inspection and test plans (ITPs) and/or change management processes such as deviation requests or non-conformance reports.

Embodiments improve on known techniques by allowing core B2B processes to be automated so as to provide real-time status feedback, determinations of progress measurement based around quality control inspection process to determine holistic integrated cumulative progress and to determine progress per manufactured item. Additionally, using the combined real-time output of different B2B processes to give real time and validated progress allows the interdependencies between processes to be modelled in advance, so when dependency risks are realized, flags are immediately raised and human error from assessing risks is minimised. Alternatively, or additionally, embodiments may deliver forecasted delays to work breakdown structure (WBS) tasks from workflow data. The output of the workflows may yield data that is fed back into a schedule, that has already been imported, to determine the knock on effects of delays that have been forecasted. The interdependencies in the schedule WBS may already determined in a model that has been imported (such as from another software). In this embodiment, interdependencies may not modelled because they are obtained from the imported data. Embodiments deliver forecasted delays to WBS tasks from the workflow data. The schedule impacts are then simulated by embodiments and reports provided to management in real time.

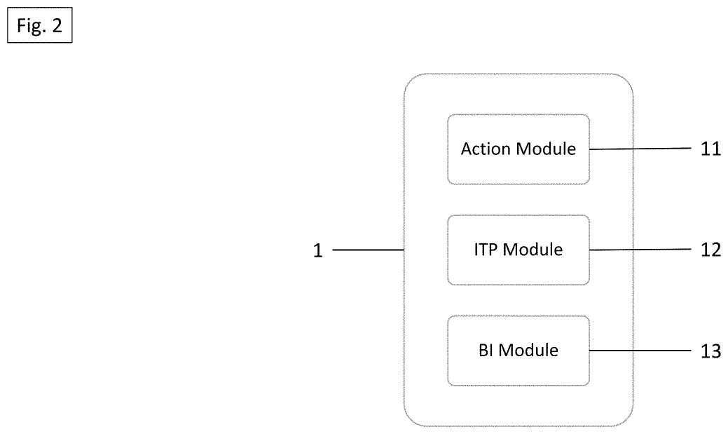

Embodiments include a computer-implemented software to enable accurate and fast reporting of the status of supply chain and site activities. In some embodiments, the computer-implemented software is provided on a web-based platform, such as a cloud computing system. Embodiments may include a system of integrated modules provided in the web-based platform, for use by a client and SCPs, to allow interaction during execution of projects and purchase orders. Clients and SCPs may be regarded as users of the web-based platform. The modules may include an action module, an inspection and test plan (ITP) module, and a business intelligence (BI) module. FIG. 2 shows a web-based platform 1, including an action module 11, an ITP module 12, and a BI module 13, in accordance with embodiments of the present invention.

The action module 11 may control business-to-business (B2B) processes. Alternatively, or additionally, embodiments may operate vertically and/or horizontally through actors on the project. For example, embodiments may operate vertically between a client, the client's main contractor and subcontractor/supplier. All three parties can be on a single workflow. Also, the workflows may operate horizontally in the supply chain, meaning the client's contractors can formally communicate with each other via workflows (with the client's oversight.). The action module may breakdown processes to action parts. An action part represents a formal step in the process requiring one business such as a SCP to communicate with another business such as the client for approvals. An action part has an internal review workflow within the business before being formally approved and automatically transmitted to another business. Review and approvals within the workflows may be done by user electronic signatures.

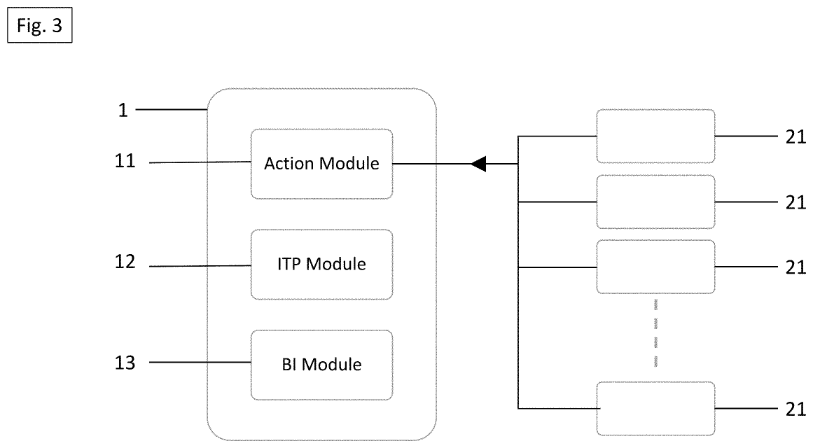

A user may interact with the web-based platform 1 via the action module 11. FIG. 3 shows a plurality of SCPs 21 which communicate with the action module 11 in accordance with embodiments. In embodiments, one or more SCPs (i.e. one or more users) generate workflow data and send the generated progress report, or workflow, data to the web-based platform via the action module. The action module provides the web-based platform with a plurality of standardised workflow formats for SCPs to input data into. This enables workflow data to be captured and provided in a standardised format which can be recognised and processed by the web-based platform. Workflow data submitted by the SCPs may be based on work complete since the last project milestone, or at a level of detail not offered or measured in the project schedule.

The action module may control processes such as: queries; hazard and operability study (HAZOP); Hazard Identification (HAZID); Layers of Protection Analysis (LOPA); model reviews; inspection notification; non-conformances; observations; corrective action; preventative action; root cause analysis; checklists; surveillance reports; mechanical completion inspection and test records; punch; outstanding work; material movement; inspection release; lessons learned; requests for information; interface requests; Health and Safety Executive (HSE) compliance checklists; HSE incident reports; inspection and test records; defects reports; milestone payments; inspection release certificates; material movement tickets; and other processes.

In some embodiments, the action module may enable multimedia to be uploaded. In some embodiments, multimedia may be provided as part of the standardised workflow data. The multimedia may comprise: pdf, pictures, and/or video which may be inserted or attached to support each communication.

Embodiments may host key project management workflows to manage inter-company approval processes as part of the action module. The workflows cover all disciplines within the project e.g. engineering, quality, Health, Safety, Security and Environment (HSSE), mechanical completion and final delivery, thus providing a complete package for a Project/Delivery Manager. For example, engineering workflows may include interface requests, deviations, concession requests and clarifications, HAZOP, HAZID, LOPA, and/or 3D Model Review. Quality workflows may include inspection notifications, inspection reports/checklists, audit reports, non-conformances, observations, and/or corrective actions. Mechanical completion workflows may include ITRs, punch items/punchlists, and/or Outstanding Work (OWL). HSSE workflows may include tool box talks, health safety and environment (HSE) surveillance reports, and/or audit reports. Delivery management workflows may include milestone payment certificates, inspection release notes, and/or material movement tickets.

Each workflow may accommodate multimedia such as sketches, diagrams, pictures, drawings, videos (to give a record of a test for example). A home page of the web-based platform may provide immediate access to the actions and their status in any part of the internal and external approval process.

The action module may integrate with other corporate management systems e.g. document management systems, data management, procurement systems, planning software, etc. This allows the information within those systems to be linked to workflows.

Embodiments may use an inspection and test plan (ITP) module 12 to monitor the status of a project based on workflow data, inspection and test statuses, and defects reported through workflows. The ITP module 12 is in communication with the action module 11. The ITP module generates an ITP in dependence on the received workflow data by the action module. The ITP module may automatically generate the ITP in dependence on the received workflow data. Alternatively, or additionally, an ITP may be generated in the ITP module without dependence on the received workflow data and/or any other module. The actual status of the ITP line items (manufacturing steps) may be updated in real-time whenever new data is received by the action module.

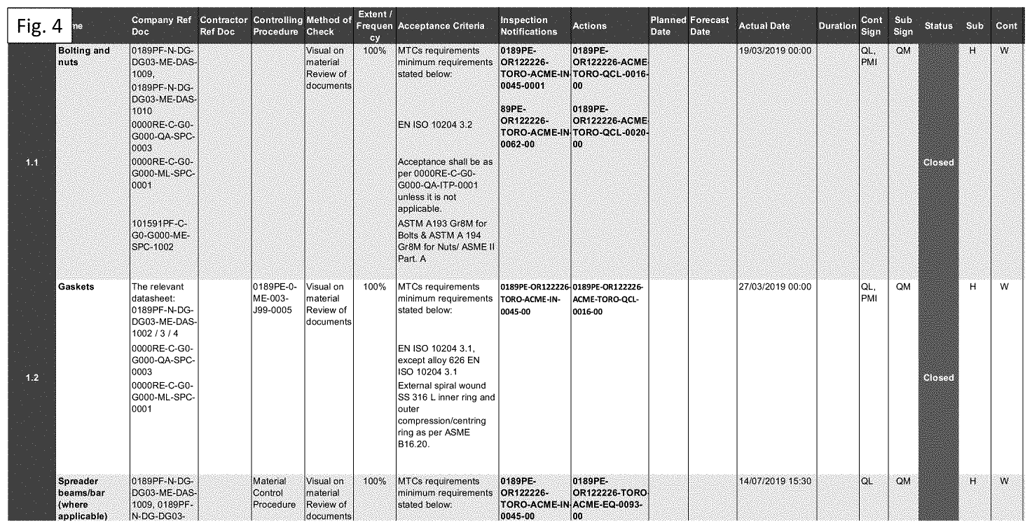

An ITP lays out all the manufacturing or construction steps for a physical product in individual ITP line items. An example of an ITP in accordance with embodiments of the present invention is shown in FIG. 4. Key attributes may be assigned to each line item to provide the inputs needed to plan the work, as well as stipulating intervention points, required by the various stakeholders, in that ITP line item. The ITP line items combine to form the ITP. The ITP module 12 is able to generate, update and manage all of the ITPs that exist for a project. The submitted workflow data by each SCP in the standardised format relates to one or more of the ITP line items.

In embodiments, the ITPs and workflows may all contain, Purchase Order, tag and serial number information such that progress status and workflow data/reports can be easily presented for these attributes. This can be useful at the end of projects because embodiments, by virtue of the fact that everything is digital and linked to these key attributes, allow a user to compile consolidated final manufacturing/construction records for archiving at the click of a button. This process may otherwise take weeks or months. Embodiments therefore expedites project closure and vendor/subcontractor payment. The workflows of embodiments may therefore provide validation of inspection records contemporaneously with manufacturing/construction progress.

In one or more embodiments, the ITP module includes one or more of standardized ITP fields, including dates for activities e.g. planned, actual, forecast, etc. Supply chain ITP activities, their planned dates and intervention points may be programmed into the software to create a baseline scope to be measured against. Embodiments may measure progress of ITP line items using ITP intervention points. An intervention point is a key point in the manufacturing or construction for a physical product, because it is a check point that the manufactured product meets the client's specifications. Typically, an intervention point requires a validation inspection or surveillance to be carried out. A validation inspection or surveillance may involve the client sending out an inspector to the relevant SCP in order to validate that the manufacturing or construction step has been performed to the client's specifications.

In some embodiments, the ITP intervention point validation inspection or surveillance is automatically scheduled in dependence on the workflow data stored in the ITP module. The ITP module may predict when a line item is expected to be completed, and may automatically report schedule variations if inspections are late. This may ensure that validation inspections are performed in a timely manner once a line item is ready to be inspected.

In some embodiments, scheduling an ITP intervention point is initiated by an SCP sending an invitation notification to the action module. Once processed by the client, the date of the intervention point validation inspection is then automatically assigned to that individual ITP line item. The status of the line item may automatically change, e.g. to ‘complete’. The actual dates of the validation inspections may then be mapped against the planned dates to determine progress.

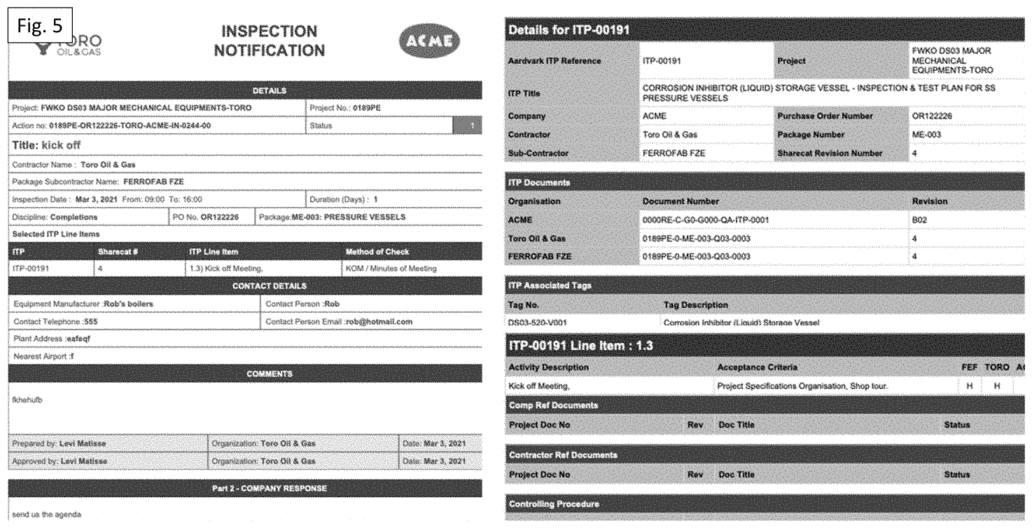

In one or more embodiments, before a validation inspection is scheduled, an inspection notification workflow may be initiated by the SCP. In response to an initiation from the SCP, the inspection notification workflow may be automatically generated. FIG. 5 shows an example of an inspection notification workflow in accordance with embodiments of the present invention. The inspection notification workflow may be populated with all of the relevant information for the notification from the ITP module, such as intervention points, reference documentation, location, etc. After the inspection notification workflow is initiated and SCP data is included, it then goes on a structured workflow for approval from the client. When the inspection date and duration is agreed, the status for the ITP line item is automatically updated in the ITP and note made of the date.

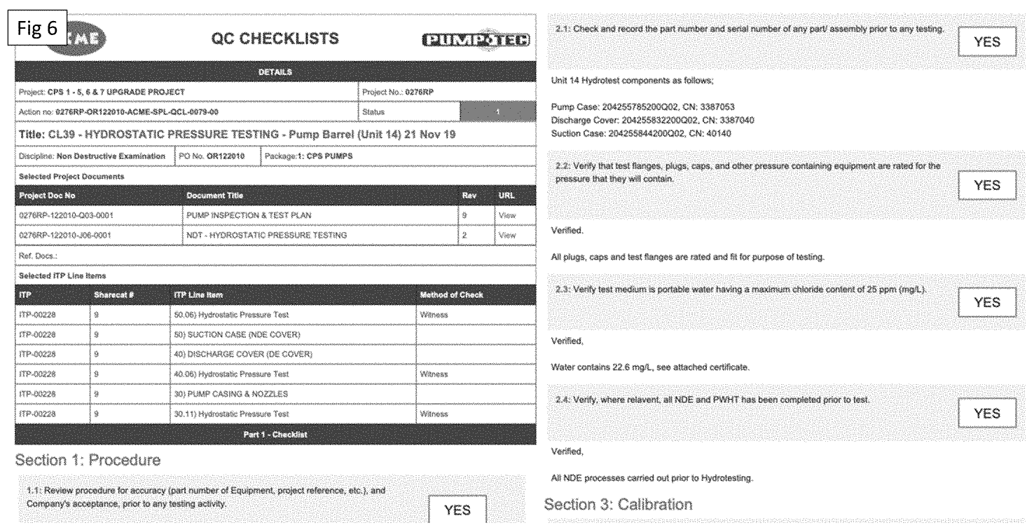

In one or more embodiments, the ITP module may be provided with a library of checklists and surveillance report formats based around client specification requirements. The action module 11 may automatically generate an inspection checklist for an interaction point validation inspection. FIG. 6 shows an example of an inspection checklist in accordance with embodiments of the present invention. These checklists and reports provide quick and easy ways to record the output from hold, witness, monitor, surveillance and review interventions. These records are important to give the client real time confidence that the SCP is carrying out the right level of surveillance and monitoring. Ultimately the feedback from these reports improves quality and HSE in the supply chain as well as identifying trends and areas where focus is needed. This is a focussed approach that can be used to justify a reduction in surveillance where good results are noticed, hence save time and money. Furthermore, the problem areas and problem vendors can be identified.

Action type checklists may comprise HSE Checklists such as confined space entry, control of work, energy isolation, lifting operations, permit to work, working at heights; quality checklists such as material receipt, quality plan checklist, material test certificate (metals), PV head inspection, positive material identification, duplex material, welding procedure qualification (WPQ)—carbon steel, welding process control, welding production audit, consumable control, hydrotest pack readiness, vessel-piping fabrication processes, piping fabrication, erection and testing processes, structural welding and erection processes, visual examination, NDE processes, dimensional control, pressure testing process, coating and lining pre-inspection checks, protective coatings processes (external), protective coatings processes (internal), instrumentation installation and testing processes, electrical/instrument cables/ladders, instrument tubing fittings and accessories, general mechanical checklist, stainless steel pressure vessels, weighing, chemical cleaning, operability & maintainability, intrinsically safe systems, lifting appliance checklist, land transport go-no-go dashboard, marine transport (in land waterway) go-no-go dashboard, despatch dossier toc, NACE material certificate acceptance criteria; and inspection reports such as subcontractor inspection report, centrifugal pumps (performance test report), centrifugal pump (inspection report), instrumentation equipment, electrical cable and control cable and fittings, transformers and reactors, variable frequency drives, electric motors, gate, globe, ball and check valves, electrical distribution processes, pipe, pipe fittings & flanges, welded unfired pressure vessels, lube, seal & control oil systems, castings, structural, piping, pumps, relief valves, contractor's weekly worksite report, daily painting inspection report, painting final inspection report, index for raw material & traceability, and/or baseline inspection report.

On completion and client approval of the checklists/reports, the ITP module may automatically update the ITP with the ITP validation inspection result with evidence of the success/failure of the test or inspection. The ITP module may automatically update the ITP by crediting the ITP with progress for that line item. All reports are automatically logged against the ITP line item and hyperlinked for future retrievability.

Failed inspections, or defects, are recorded and processed by other B2B web-based workflows provided in the action module 11 that mange non-conformance reports, punch list items, observations, and corrective actions. These workflow actions negate the potential progress that may have been earned for that ITP line item activity, until they are approved by the client.

In one or more embodiments, information in the ITP module may be used as searchable input data to other action types in the system, such as, inspection notifications, non-conformance reports, queries, observations, and punch. The system may be programmed to read output data from actions linked to the ITP line items to provide automatic live progress status updates for ITP line items.

In one or more embodiments, the ITP module may additionally be integrated with other workflows to automatically collect output data, such as status and dates, and also to provide input data to those workflows.

In one or more embodiments, the web-based platform 1 may read and import other industry planning software files, such as MS Project and Primavera. The line item activities (i.e. tasks) can be linked to the invention's ITP module, such that when validation inspections happen, it can be automatically related back to the client's schedule to verify and validate claimed progress by the vendor. This provides an accurate and effective way of giving feedback as to the status of supply chain progress.

The business intelligence module has a machine learning function that reads a plurality of data within each of the actions generated in the system and to develop a model based on metadata. The model may give predictive forecasts as to the expected completion data of actions after being compared with past data. The model is a learning model and will adapt to become more accurate with more data that is gathered. The forecast dates are then compared with the planned dates to give early warning signs to the project manager. Suggested actions may also be provided to assist the project manager. This machine learning element is continuously running and such that each action is being assessed against the schedule and past data to give live feedback as to the schedule risks.

The inspection data such as date, duration, attending inspectors, location, etc is captured for dashboard feedback, such as S-curves on the status of a particular purchase order based on verifiable completed activities.

Project progress may be presented to the client in a multitude of ways, such as a whole project view providing a holistic integrated view of the supply chain, or presented at a micro-level to see the manufacturing status of individual components.

Business analytics are technologies and practices for obtaining business intelligence (BI) for continuous iterative exploration and investigation of past business performance to gain insight and drive business planning and data informed decision making.

Traditionally, employees are not trained or equipped to manage the large amount data which is generated, resulting in a long delay between receiving the data and obtaining the relevant information from the data. This can result in it being too late to make an optimal decision. A challenge is to be able to process data quickly to give business insights.

Embodiments of the present invention may include a business analytics module to obtain data from other modules and processes the data in real-time. The ITP module is arranged to generate data which not only allows for the validation inspections to be scheduled and carried out, but also in a format suitable for analytics to be performed.

The BI module 13 may consolidate internal data from the B2B processes with multiple external sources of data from other project systems to a single platform. The business analytics module may then make determinations based on the combined data to identify new correlations regarding the status of the project. This may provide greater insights, and also recommendations can be made to avoid and/or reduce risk.

The BI module may present information in real time, avoiding waiting until monthly or weekly cut-off dates, thus avoiding the traditional reporting delay.

The BI module may show the current status on critical items e.g. status of delivery of PO line items, open actions, rejected documents, etc. The BI module may also show trends and/or operating bandwidths that are being exceeded, e.g. trends for the numbers of open EQs and HAZOP actions per month/week, punch run down curves, to give early warning signs to the Project Manager.

The BI module may determine and output various performance related metrics, e.g. gauges that look at the average response times for closure of actions, which party is holding up documents, and shows when performance is slipping compared to set targets, or against the norms in the system from across projects/POs. Correlations of KPIs between the number of actions and/or defects raised per inspection shows the comparatives quality and HSE performance of particular contractors. The interface between the BI module and the ITP module allows automatic flagging and reporting when activities have slipped and/or been misreported.

The BI module automatically processes the data in the system including data provided in the ITP module, alongside data from actions, ITPs, and interfacing systems, to automatically report the project status at any level of the supply chain via live dashboards. The BI module is programmed to analyse the ITP status to provide information regarding the status of each ITP, which can be consolidated at various levels to provide a comprehensive and holistic view of manufacturing and/or construction status across all supply chain purchase orders; the digital programming of ITPs and linkage to actions statuses yields a state-of the-art automated schedule validation tool. The tool operates in a real-time environment enabling immediate interrogation of the whole supply chain. Exports to interfacing software are available to facilitate status progress updates in said software. The system is arranged to compare and correlate system data to provide alerts and recommendations, such as determinations of risks to delivery and actions that may be taken to mitigate the risks.

In one or more embodiments, the BI module is configurable to utilise data to monitor and report on all levels of supply chain performance to enable businesses to tailor corporate KPIs and benchmarks to continuously improve the processes and performance of businesses that use the platform.

In one or more embodiments, the web-based platform may have an associated app to allow users to view the system BI and allow actions to be processed on mobiles or laptops from field or non-office locations.

In one or more embodiments, the BI module includes artificial intelligence systems trained on historic trends to continually run background analytics across all business and users to monitor and run calculations on all system data. The BI module may then make predictions based on the artificial intelligence systems to identify ITP line items which are at risk of being delayed based on past performance.

In one or more embodiments, the BI module is able to determine and show an overall risk matrix, which identifies top risks to focus on resolving with suggested actions to be taken. The data enables executive action to be taken immediately, and delays are identified to avoid further downstream delays. Corporate risk acceptance criteria thresholds may also be provided as a data input to the business analytics module, in order to prescribe escalation routes for the information presented so that high risk actions are monitored at the commensurate level of the business.

In one or more embodiments, the business analytics module may flag any anomalies and risks e.g. differences in planed and actual dates. This information is useful when trying to determine hold-ups and delays by comparing the information to the supplier's baseline schedule. The system not only tells the exact status of what has been inspected. The system may identify problematic or failed inspections and reports the status, using for example, red colouring. If these issues remain unresolved at the micro level, they are soon flagged on management dashboards, thus giving rapid escalation of previously hidden risks.

Anomalies and risks may be identified based on one or more metrics. Metrics are specific units of actual measurement of data identified as relevant or critical to the project management schedule, which are also referred to as parameters of the workflow data. Metrics are calculated based on the workflow data and may have a defined unit of measurement, i.e. days, hours, number of documents. Analysis of metrics may identify leading indicators as to the forecasted problems, and/or lagging indicators showing things that are currently off track.

Metrics may be grouped in various ways, for instance, by project, by Purchase Order, by package, by supplier or by date. Metrics may also be derived using algorithms and mathematical formula, i.e. Average, Min, Max, etc. Metrics may also be combined to create compound metrics, for instance number of Punch actions raised per NCR.

Metrics may be interpreted by the system to determine risk and status to various critical elements, such as Project, Purchase Order, Package and provide indicators (visual and otherwise) to the user. As an example, a metric-based determination of “<98% documents are code 1 at Rev 03 for a Project” may flag as an “Amber” risk.

An example of some metrics are now provided: Number of document revisions at Code 3; Number of Doc's that have missed first issue planned date; Doc process cycle time>14 days for comments incorporation; Doc process cycle time>14 days for Company review; EQ process cycle time>14 days for Company review at Part 3 and 5; Process cycle time>14 days for NCR answers; Schedule (primavera): actual date is >planned date; Inspection: actual date is >planned date; Days to close Punch; Number of NCRs; Number of documents code 1 at Rev 03; Number of document revisions to code 1, 4 or NR; Days taken to get approval code 1, 4 or NR; Days taken to get approval code 1, 2, 4 or NR; Number of actions raised per inspection. (Document code meanings: Code 1=approved; Code 2=approved with comments; Code 3=rejected; Code 4=submitted for information; NR=Not reviewed)

Metrics are designed to take measures from areas of the project that may cause project delays, cost overrun, or change in scope, quality or health and safety. The metrics measure planned activities, and the risks associated with unplanned activities.

The metrics measure leading risk indicators to predict the outcome of actual events in these plans before they happen i.e. provide accurate forecasting. Likewise, the unplanned activities, events or actions are assessed, via specifically designed metrics, to look at the probability of impact on any of the project management pillars (cost, schedule and scope) and corporate governance objectives.

The metrics are determined based on the workflow data. It does this by digitising many workflows that were previous paper driven, thus enabling capture and validation of data at a low level. The data is then processed by the metrics to yield results, which are in turn further analysed using six sigma tools to determine statistical profiles and norms for the metric. A machine learning model is then developed for each metric to perform a specific tasks without using explicit instructions on the data that is received in the system on a continual basis. Trends are analysed and then the model will provide alerts to the user and recommended action when certain thresholds within the norms are exceeded. The end result is a continuous project monitoring system that alerts the user when things are forecasted to be delayed, and provides executive action suggestions to bring it back on track.

Metrics may be used to: determine the relative importance of documents to the overall schedule, and to auto calculate the criticality of documents; determine thresholds and norms for document approval; measure the relative importance of certain actions to the overall delivery and then forecast time to close and overall impact on any linked activities, such as milestones like HAZOP.

Metrics may be used to identify the actual status of the ITP line item activities, the risk of missed ITP intervention points and the impact on the package delivery. Metrics may also be used for the cumulative assessment of progress across more than one ITP, and/or for the cumulative assessment of progress of package delivery, or multiple package delivery.

Metrics may also be used to measure the relative importance of certain actions to the overall delivery and then forecasts time to close and overall impact on any linked activities, such as package release.

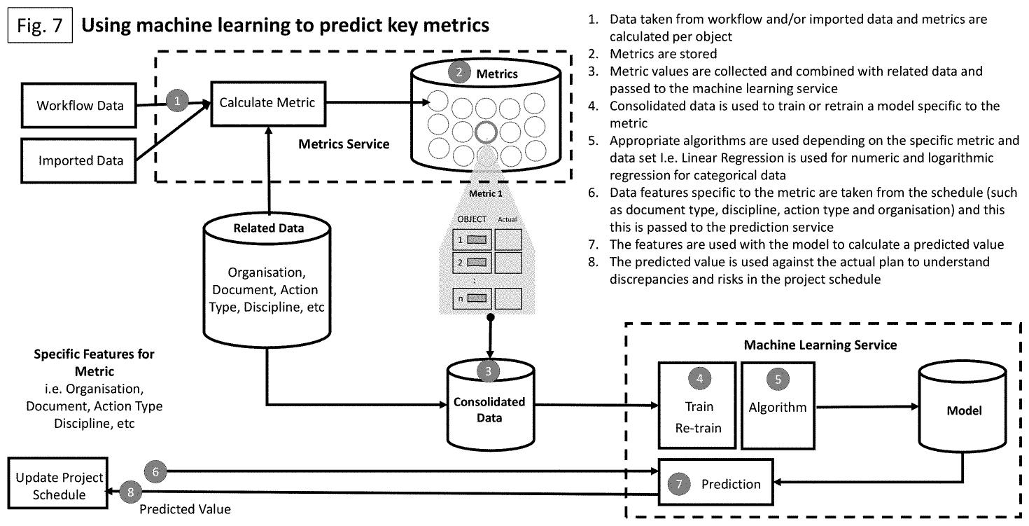

Metrics may be analysed using a machine learning algorithm trained on historical data in order to make predictions relating to the project schedule, which includes the expected completion dates of inspection and test plan line items. The same machine learning algorithm may also identify key metrics based on correlations between changes in the overall project schedule and various parameters described above. A method of using machine learning to predict key metrics, and updating the overall project schedule is shown in FIG. 7. In FIG. 7, data taken from workflow and/or imported data and metrics are calculated per object (1), metrics are stored (2), metric values are collected and combined with related data and passed to the machine learning service (3), consolidated data is used to train or retrain a model specific to the metric (4), appropriate algorithms are used depending on the specific metric and data set I.e. Linear Regression is used for numeric and logarithmic regression for categorical data (5), data features specific to the metric are taken from the schedule (such as document type, discipline, action type and organisation) and this this is passed to the prediction service (6), the features are used with the model to calculate a predicted value (7), the predicted value is used against the actual plan to understand discrepancies and risks in the project schedule (8).

The web-based platform 1 may have the ability to read other critical softwares used in project controls, such as project gantt charts used to measure and report schedules and the linked activities within these charts. The software can link the output of the model's schedule risk to a master project schedule, so for example, if a package delivery is showing a forecasted delay, or a risk to delay (with a degree of confidence), then the impact of this delay can easily be simulated within the invention so as to show the consequential impact on the critical path, or other non-critical paths that may be relevant. The result is an invention that can produce a continuous auto-updating project schedule and risk forecasting tool that gathers this data from its workflows that measure non-planned events, ITPs and other integrated data sources.

Optimization of the inspection and surveillance management process by incorporating schedule data and integrating the ITP with other critical action workflows, may yield useful data that is used to provide accurate forecasting in real time. By expanding this out to the full supply chain, a large amount of useful data is obtained. Thus, quality inspections may also report schedule progress and report risks. Revealing the risks in a timely manner, at the right level, may improve the management of the project and avoid cost overruns.

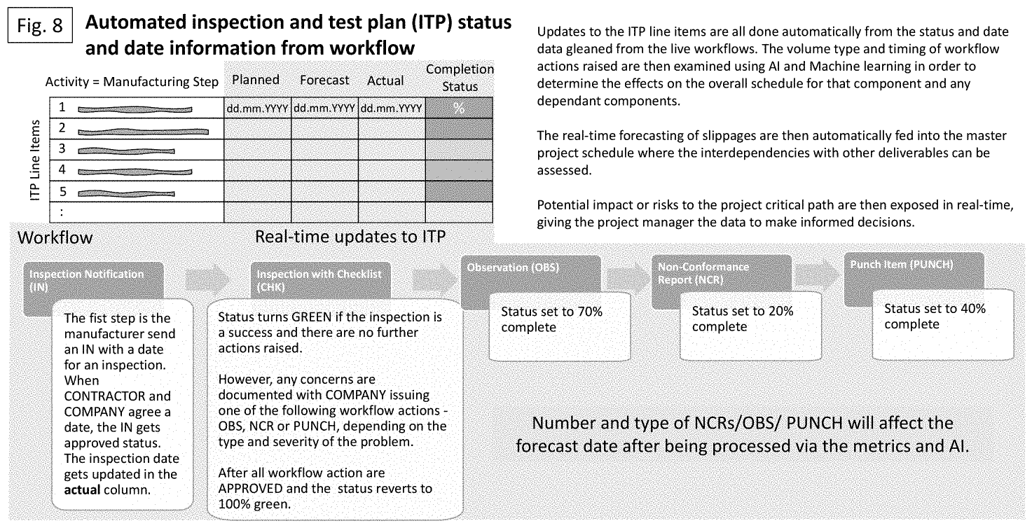

FIG. 8 shows how an inspection and test plan status can be automatically updated according to an embodiment.

Embodiments of the invention also include a number of modifications and variations to the embodiments as described above.

In particular, the web-based platform 1 according to embodiments may be used to reduce the amount of re-work that is required in projects. Re-work is the repeating of the task due to the task not being correctly performed the first time. Re-work may account for 10-25% of the overall cost of a project.

Re-work is by its nature unplanned; it repeats the original work that was found not to be in accordance with the specification. The final cost of carrying out the work is, therefore, significantly more than original planned cost due to the additional costs of: controlling/reporting non-compliant work; removing the defective work; determining the root causes for the non-compliance; preparing re-work method statements; procuring new material; accelerating the schedule to make up for the lost time; carrying out the re-work itself; re-inspection after completion of the re-work; documentation the re-work on engineering drawings, etc.

Each company in a project may have their own way of recording and analysing non-conformities. This often means that non-conformities (which may alternatively be referred to as errors) are defined and managed in isolation. The definition of non-conformities often varies from company to company and can be restricted to just physical defects in the items begin manufactured to physical and process related errors. Some companies grade them in terms of severity and others do not.

The web-based platform 1 according to embodiments may provide a single web-based technological tool to enable a project to introduce a common reporting standard to bring about control the area of re-work in a consistent manner. The web-based platform 1 according to embodiments may do this because at its core it has workflows that are designed to record errors at all level of the supply chain i.e. Owner, engineering contractor, contractor, subcontractor and supplier.

In addition, the web-based platform 1 according to embodiments may integrate other common management tools that exist on projects where errors are also recorded e.g. document managements systems, such that errors are brought together in one place.

Finally, the web-based platform 1 according to embodiments may also integrate the workflows with other data sources (e.g. the project schedule, tags, inspections, etc) such that metadata can be attributed to errors. This is powerful because it means errors can have multidimensional attributes which enables vastly improved analytics.

In order to achieve this, the web-based platform 1 according to embodiments may perform the below-described Steps 1 to 4.

Step 1—Definition of Error

The web-based platform 1 according to embodiments may define error as the execution of a planned task that leads to re-work due to the work being non-compliant i.e. that has resulted in, or has the potential to result in, more time or cost that than originally planned or anticipated to achieve a task or work.

Step 2—Systematic Approach

The web-based platform 1 according to embodiments may be used as a single digital platform for all parties on a project (Owner, Engineer, Contractor, Subcontractor, supplier, etc) to connect, capture errors and report them. In capturing the error, the costs and schedule impacts can be proposed as well as well as the causes are captured.

A single system according to embodiments standardises the approach to deliver consistent and correct reporting. It also provides a means to obtain a complete picture of the causes of error across every contractual tier of the project.

Step 3—Measurement

The web-based platform 1 according to embodiments may measure error via a set of error indicators, such as key performance indicators (KPIs), to provide a reliable indication of the type, frequency and cost of error.

The web-based platform 1 according to embodiments may calculate the relationship between non-commercial error KPI and schedule and costs. This may be done by detailed monitoring of the error rates in processes and their time-phased effects on the cost and schedule of a project.

The time-phased benchmarking of KPI performance across projects and contractors, gives early warnings to management of risks and suggested improvement strategies.

Step 4—Data Integration and Artificial Intelligence

The web-based platform 1 according to embodiments may implement data integration and artificial intelligence techniques. The web-based platform 1 according to embodiments may provide a single digital platform that integrates data from multiple databases in order to correlate errors with costs and schedule performance over time (time-phased). This enables a better understanding of the issues, more accurate determination of the root causes, to enable meaningful recommendations to eliminate the errors.

Firstly, the workflows may be used to determine associated re-work measured direct costs and schedule impacts, and these may be integrated with time-phased data obtained from the project schedule. This may enable errors, and their causes, to be mapped to specific tasks in the schedule.

Linking measured direct costs and schedule of re-work with activities in the schedule enables the identification high risk or critical activities. The data, and access to the root causes, enables improvements in construction techniques and methods to eliminate the root causes.

The web-based platform 1 according to embodiments may simulate the future schedule and cost impact on the integrated (project WBS and CBS) to determine potential knock-on effects to the wider schedule/budget, thus giving early insights to the project management team.

The web-based platform 1 according to embodiments may determine of the cost and schedule information of re-work progressively when the re-work occurs. As such, an immediate cumulative measure of re-work can be obtained. This may then be correlated to the CPI, i.e. cost performance index, and SPI, i.e. schedule performance index, (throughout the project) to determine a time-phased behavioural relationship between the two measures. This then provides a leading indicator of the overall expected cost and schedule impacts at the end of the project (if intervention is not carried out to prevent further escalation).

Secondly, the web-based platform 1 according to embodiments may integrate workflows with other project database systems such as document management systems, tagged items, inspection activities in the digital ITP. This enables the linking of recorded errors to items tagged being built, documents types or inspections in the digital ITP.

This enables the identification of high risk or critical items and/or continuous processes, which may not be explicitly identified in the construction schedule.

Where cost and schedule information are not recorded in the errors, the error rates (that often happen early in the project) may be correlated with cost and/or schedule delays (that often manifest themselves often later in the project) to provide early warnings to project management of impending risks.

Where cost and/or schedule information is recorded in the error, it provides direct costs associated with items and/or continuous processes and, therefore, the ability to identify high risk physical items or processes. The data, and access to the root causes, enables improvements in construction techniques and processes to eliminate the root causes.

Thirdly, the web-based platform 1 according to embodiments may measure data from other systems via error KPIs and integrate them with cost and schedule performance indicators (SPI and CPI). The error indicators may be correlated with the SPI and CPI to determine relationships between error and schedule or commercial indicators using artificial intelligence and machine learning techniques.

This provides a quantitative feedback of error rates that happen early in the project but manifest themselves often later in the project through commercial and schedule delays.

The web-based platform 1 according to embodiments may provide an integrated digital schedule that maps the errors as recorded with the schedule progress to obtain relationships and correlations between non-commercial detected errors and the lagging indicators of SPI and CPI.

Accordingly, the web-based platform 1 according to embodiments may substantially reduce the amount and/or cost of re-work and improve the management of re-work. The processes for reducing the amount and/or cost of re-work may be performed, by the same web-based platform, in addition to the earlier described techniques of an inspection plan management method.

Embodiments also include the provision of a web-based platform that may only perform the processes for reducing the amount and/or cost of re-work may be required. The earlier described techniques of an inspection plan management method may not be performed, or they may be performed by a separate web-based platform 1.

In a preferred embodiment, the web-based platform 1 is configured to determine relationships between non-commercial defect metrics and specific commercial metrics i.e. SPI and CPI. The non-commercial metrics may use data that is also non-confidential in nature (whereas commercial information may sometimes be guarded). This data may either be captured through the invention's workflows or via other data sources imported to the web-based platform 1. The web-based platform 1 may integrate the data. The web-based platform 1 may read a very large amount of data and determine these relationships, sometimes using AI and ML. The benefits of this is that the non-confidential data may provide the leading indicators of the CPI and SPI. The non-commercial defects data may show the performance of certain processes, plants and actors that operate on the project to reveal substandard quality in their work. This allows early intervention to correct the problems.

In another preferred embodiment, the web-based platform 1 may use workflows to capture real-time costs and to schedule impacts of rework (forecasted and actual) from engineering, supply chain and construction. The the web-based platform 1 integrates the capture of this data with the WBS, i.e. work breakdown structure, and CBS, i.e. cost breakdown structure, to simulate impacts to the critical path of the project and/or other activities. Using schedule's pre-programmed (i.e. imported to the web-based platform 1) network of interdependencies, the web-based platform 1 may simulate potential downstream problems this may cause allowing early intervention.

Embodiments may therefore measure, via workflows, the cost and schedule impacts of poor quality work. The automation of the processes for measuring the cost and schedule impacts of poor quality work helps to capture and deliver this information quickly and efficiently.

A defect value is the element of cost and schedule that is lost on rework. The defect performance index may be calculated in dependence on the defect value. The defect value itself is a measure of cost and schedule effects. However, it is time consuming to collate the information to record, so it is only done for major defects, if at all. It is, however, possible to measure the causes of defects and benchmark these against good and bad performing projects to get a qualitative value of performance. Embodiments include doing this measuring the defects as a ratio of the total scope performed. For example, in an engineering project, embodiments may calculate the ratio of the number of code 3 document revisions to the total number of documents submitted; and or the ratio of the number of code 3 documents at first revision to the total number of documents submitted. For example, in a manufacturing/construction project, embodiments may calculate the ratio of the number of defects to the total number of inspection interventions attended.

Embodiments include digitizing all of the workflows; ITP inspections and status of other deliverables imported from other systems e.g. documents. These may then be digitally integrated with schedule tasks and/or the WBS (which is also digitally imported) at the lowest level e.g. per workflow when it is initially raised, per inspection, per document. Embodiments may then measure the current STATUS of all of them. Embodiments may also assesses the actual/potential schedule impacts either qualitatively, by a user completing an actions impact statement, or quantitatively by predictive diagnostics using AI to benchmark current status against historical status which gives predictive completion times and hence impacts to the schedule. Embodiments bring all of these linked schedule impacts together to create a dashboard by exception. The dashboard examines all the items that are influencing the critical path right now. This may be referred to as a Pathboard. The Pathboard has two levels: items that are currently affecting the critical path and those items that are ‘just off’ critical path but also putting it at risk. This focusses the work of the project team accordingly in tackling their daily emergent risks. Embodiments may thereby provide a real time and presentation of information to users that helps them focus their efforts accordingly.

The flow charts and descriptions thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

Methods and processes described herein can be embodied as code (e.g., software code) and/or data. Such code and data can be stored on one or more computer-readable media, which may include any device or medium that can store code and/or data for use by a computer system. When a computer system reads and executes the code and/or data stored on a computer-readable medium, the computer system performs the methods and processes embodied as data structures and code stored within the computer-readable storage medium. In certain embodiments, one or more of the steps of the methods and processes described herein can be performed by a processor (e.g., a processor of a computer system or data storage system). It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that is capable of storing computer-readable information/data. Computer-readable media should not be construed or interpreted to include any propagating signals.

What is claimed is:

1. A computer-implemented method of monitoring the status of a project, the method comprising:
generating workflow data in a standardised format by each of a plurality of users, wherein each user is a participant of the project;
sending, by each of the plurality of users, the generated workflow data to a web-based platform;
receiving, by the web-based platform, the generated workflow data from each of the plurality of users;
automatically generating and updating an inspection and test plan in dependence on the received workflow data by the web-based platform; and
generating substantially real-time progress status information of the project in dependence on the inspection and test plan.
wherein:
the inspection and test plan comprises a plurality of line items, each line item corresponding to a manufacturing and/or construction step for a product;
the generated workflow data in the standardised format by each user corresponds to one or more of the plurality of line items; and
each manufacturing step is a step of manufacturing a product that is a component of a manufactured system, wherein the manufactured system includes a plurality of components with each of the plurality of components manufactured by a different user; and
the method further comprises automatically:
generating one or more metrics based on the workflow data, wherein each metric relates to a particular measurable parameter of the workflow data;
analysing the one or more metrics using a machine learning algorithm, trained on historical performance data, to make predictions relating to risks associated with the inspection and test plan; and
updating expected completion dates of one or more of the inspection and test plan line items in dependence on the analysis of the one or more metrics.

2. The inspection plan management method of claim 1, wherein:
the plurality of line items each comprise at least one intervention point; and
each intervention point is a trigger for performing a validation activity of the corresponding manufacturing step for the product to be performed.

3. The inspection plan management method of claim 2, wherein the method further comprises:
predicting, in dependence on the inspection and test plan, when one or more line items are expected to be completed; and
forecasting and/or scheduling one or more intervention points in dependence on the predictions.

4. The inspection plan management method of claim 2, wherein the method further comprises:
receiving one or more inspection notifications that line items are ready from inspection from one or more of the plurality of users; and
scheduling an intervention point in dependence on the received one or more notifications.

5. The inspection plan management method of claim 2, wherein the method further comprises:
automatically generating an inspection notification workflow in dependence on the inspection and test plan and the corresponding line item data;
wherein the inspection notification workflow contains relevant information to the intervention point such as the related validation inspection procedure, reference documentation for the validation inspection procedure, and the location of the validation inspection procedure.

6. The inspection plan management method of claim 2, wherein the method further comprises:
automatically generating an inspection checklist for each intervention point, wherein each inspection checklist is generated in dependence on specification requirements of the manufacturing step associated with the intervention point.

7. The inspection plan management method of claim 2, wherein the method further comprises:
updating the inspection and test plan with a result of the validation activity procedure.

8. The inspection plan management method according to claim 1, further comprising:
analysing the inspection and test plan using a machine learning algorithm trained on historical performance data;
determining a risk model based on the analysis of the inspection and test plan, wherein the risk model identifies a likelihood of a line item of the inspection and test plan being delayed; and
determining action suggestions in dependence on the risk model, wherein action suggestions are actions to reduce the risk.

9. The computer-implemented method of monitoring the status of a project according to claim 8, the method further comprising determining the amount and/or cost of re-worked processes in a project by:
determining if an error has occurred; and
applying data integration and/or artificial intelligence techniques in dependence on data that is determined for each error that occurs so as to determine the amount and/or cost of re-worked processes in a project.

10. A computing system configured to perform the method of monitoring the status of a project according to claim 9.

11. A computer program that, when executed in a computing system, causes the computing system to perform the method of monitoring the status of a project according to claim 1.
